(19) United States
(12) Patent Application Publication
(10) Pub. No.: US 2005/0084660 A1
(43) Pub. Date: Apr. 21, 2005

(54) Information recording medium and information recording method

(76) Inventors: Kyoko Kojima, Kunitachi (JP); Motoyasu Terao, Hinode (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/933,214

(22) Filed: Sep. 3, 2004

(30) Foreign Application Priority Data
Oct. 17, 2003 (JP) 2003-357213

(51) Int. Cl. B32B 3/00

(52) U.S. Cl. 428/209

(57) ABSTRACT

The present invention relates to an information recording medium for recording and reproducing information using light and an information recording method to attain high-speed recording and high-density recording. An electrolyte layer 2 is sandwiched by the first conductive polymer layer (an electrochromic layer) 1 comprising a conductive polymer electrochromic material and the second electrolyte layer 7, and both sides of the first and the second conductive polymer layers are sandwiched by electrode layers 3 and 4. The heat generation area in recording is so narrow that some drift in auto-focusing and tracking is allowable, which enables high-speed rotation leading to high-speed recording and high-density recording.

### INCORPORATION BY REFERENCE

The present application claims priority from Japanese application JP2003-357213 filed on Oct. 17, 2003, the content of which is hereby incorporated by reference into this application.

### BACKGROUND OF THE INVENTION

The present invention relates to an information recording medium for recording and reproducing information using light and an information recording method.

Features of an optical disc are that the recording medium (disc) is detachable to a record reproducing device and is inexpensive. Therefore, an optical disc device is desirable to attain higher-speed and higher-density operation without losing these characteristics.

Various principles are known for information recording by irradiating light on a recording film. Among these, the one that makes use of thermal change in atomic configuration, such as phase change (also called phase transition or phase transformation) of a film material has an advantage that an information recording medium capable of writing-in many times can be obtained. As described in, for example, JP-A-2001-344807, basic structure of these phase change type optical discs on a substrate comprises a protective layer, a GeSbTe-based recording film, a protective layer and a reflecting layer.

On the other hand, a field-effect type optical disc is known, where information is recorded on a phase change recording film by irradiating a laser beam on a recording film under impression of electric field. Such disc uses element structure that a phase change information layer such as GeSbTe-based film is sandwiched between up and down electrodes. This field-effect type optical disc is described in, for example, JP-A-63-122032. The field-effect type optical disc takes advantage of the phenomenon that an electric field impressed on a recording film promotes more phase change (crystallization) than just laser beam irradiation.

An experimental result that irradiation of light under voltage impression by transparent electrodes, which sandwich a photoconductor and a phase change recording film enables recording by using nearly 2 digits weaker laser beam than the case of light irradiation only, is reported in the paper of the present inventors: “Highly Sensitive Amorphous Optical Memory” (M. Terao, H. Yamamoto and E. Maruyama, supplement to the J. of the Japan Society of Applied Physics, Vol. 42, pp 233-238).

### SUMMARY OF THE INVENTION

As an optical disc is characterized by being detachable to a device and inexpensive by using a plastic substrate as a recording medium, up-and-down swing and eccentricity at the periphery of the disc are inevitable. The up-and-down swing and eccentricity occur in high frequency with increase in rotation speed, resulting in difficulty in follow-up by auto-focusing or tracking. Therefore, it is necessary for a recording medium to be lenient with tracking drift or the like, especially in vulnerable recording, in order to attain high-speed recording over follow-up limit for mechanical vibration of a device.

However, there is no possibility that either a land or a groove is easy to record, because the land and the groove are subjected to almost the same voltage and light absorption in the technology described in the paper of the above supplement to the J. of the Japan Society of Applied Physics Vol. 42 and a field-effect type medium described in JP-A-63-122032. Therefore, an allowable level for tracking drift is not high enough for satisfactory high-speed recording.

An object of the present invention is to solve these problems, to shorten the period for layer selection and to attain large-capacity super-high speed recording.

Other objects, features and advantages of the invention will become apparent from the following description of the embodiments of the invention taken in conjunction with the accompanying drawings.

### BRIEF DESCRIPTION OF THE DRAWINGS

FIG. 1 shows a composition of an information recording medium of the present application.

FIG. 2 explains resonance structure of polythiophene which is a conductive polymer electrochromic material used as an information layer of an information recording medium of the present invention.

FIG. 3 represents molecular structure change on doping to polythiophene.

FIG. 4 represents electron state of a non-degenerated conductive polymer by band structure.

FIG. 5 represents electron state of an inorganic semiconductor by band structure.

FIG. 6 shows structure of an electrochromic compound used as an electrochromic layer.

FIG. 7 shows three different types of oxidation states of polyaniline.

FIG. 8 shows electron state of a conduction band of tungstic oxide in mixed state of atomic valences.

FIG. 9 shows structure of an information recording medium in Examples of the present invention.

FIG. 10 shows structure of an information recording medium in Examples of the present invention.

FIG. 11 shows structure of an information recording medium in Examples of the present invention.

FIG. 12 shows an electrode of a disc holder part which sets therein an information recording medium in one Example of the present invention.

FIG. 13 shows an absorption spectrum of an electrochromic layer of an information recording medium in Examples of the present invention.

FIG. 14 shows time change in light transmission ratio at 660 nm wavelength of an electrochromic layer of an information recording medium with change in impressed voltage in Examples of the present invention.

FIG. 15 is a block diagram of a circuit for controlling impressed voltage to a medium in Examples of the present invention.

FIG. 16 shows an absorption spectrum of an electrochromic layer in Examples of the present invention.

FIG. 17 shows an electrode of a disc holder part which sets therein an information recording medium in Examples of the present invention.

FIG. 18 is a block diagram of a circuit for controlling impressed voltage to a medium in Examples of the present invention.

FIG. 19 shows structure of an information recording medium with four layers in Examples of the present invention.

FIGS. 20(a) and 20(b) show principle of the present invention.

### DESCRIPTION OF SYMBOLS

1: the first conductive polymer layer,
2: an electrolyte layer,
3: the first electrode,
4: the second electrode,
5: an electric source,
6: light,
7: the second conductive polymer layer,
8: aromatic type structure of polythiophene,
9: quinoid type structure of polythiophene,
12: molecular structure of polythiophene in neutral state,
13: one electron oxidation reaction by acceptor doping to polythiophene,
14: molecular structure of polythiophene in one electron oxidation state,
15: a relaxation process,
16: polaron state,
17: bipolaron state,
18: one electron reduction reaction by donor doping to polythiophene,
19: one electron oxidation reaction by acceptor doping to polythiophene,
20: one electron reduction reaction by donor doping to polythiophene,
21: band structure in neutral state,
22: a valence electron band,
23: a conductive band,
24: a width of a forbidden band,
25: energy of an electron,
26: allowable transition,
27: band structure in positive polaron state,
28: a polaron level P⁺,
29: a polaron level P−,
30: allowable transition in polaron state,
31: band structure in bipolaron state,
32: a bipolaron level BP⁺,
33: a bipolaron level BP−,
34: allowable transition in bipolaron state,
40: energy of an electron,
41: a conductive band,
42: a valence electron band,
43: a forbidden band,
44: a width of a forbidden band,
45: a donor level,
46: ground state of a conductive band,
47: an acceptor level,
51: polythiophene,
52: polypyrrole,
54: polyaniline,
55: poly(3,4-ethylenedioxythiophene),
56: poly(3,4-ethylenedioxypyrrole),
57: poly(3,4-dimethoxythiophene),
58: poly(3,4-butylenedioxythiophene),
59: poly(3,4-dimethyl-3,4-dihydro-2H-thieno[3,4-b][1,4]dioxepin),
60: alkylated derivatives of poly(3,4-ethylenedioxythiophene),
90: the first conductive polymer layer,
91: a protective layer,
92: the first electrode layer,
93: an electrolyte layer,
94: the second conductive polymer layer,
95: the second electrode layer,
96: a UV cure type resin,
97: a plastered protective substrate,
98: a substrate,
99: a groove part,
100: a land part,
101: an incident laser ray,
110: a plastered substrate,
111: a laminated film,
112: a transparent electrode,
113: a transparent electrode,
114: a lead electrode from a transparent electrode,
115: a lead electrode from a transparent electrode,
116: a disc center,
117: space between electrodes,
118: a fine metallic electrode,
119: a fine metallic electrode,
130: the second conductive polymer layer,
131: a protective layer,
132: the first electrode layer,
133: an electrolyte layer,
134: the first conductive polymer layer,
135: the second electrode layer,
136: a UV cure type resin layer,
139: a land part,
140: a groove part,
141: a rotating shaft,
142: the first slip ring,
143: the second slip ring,
144: the third slip ring,
145: the first contacting electrode,
146: the second contacting electrode,
147: the third contacting electrode,
148: a disc holder,
149: an insulator,
150: a convex part for positioning,
151: a visible absorption spectrum of an information layer on impressed voltage of 0 V,
152: a visible absorption spectrum of an information layer on impressed voltage of +3.0 V,
153: coloring concentration necessary for recording and reproduction,
160: a photo-disc,
161: an 8-16 modulator,
162: a circuit for recorded waveform generating,
163: a laser driving circuit,
164: a photo-head,
165: an 8-16 demodulator,
166: a pre-amplifier circuit,
167: an L/G servo circuit,
168: a motor,
169: signal input,
170: signal output,
171: a visible absorption spectrum of an information layer on impressed voltage of −1 V,
172: a visible absorption spectrum of an information layer on impressed voltage of +3 V,
181: a rotating shaft,
182: the first slip ring,
183: the second slip ring,
184: the third slip ring,
185: the first contacting electrode,
186: the second contacting electrode,
187: the third contacting electrode,
188: a disc holder,
189: an insulator,
190: a convex part for positioning,
201: a layer selecting signal,
202: a variable electric source,
203: a layer selecting circuit,
204: a current controller,
205: a signal for selecting the first layer,
206: a signal for selecting the second layer,
207: a signal for selecting the third layer,
208: a signal for selecting the fourth layer,
210: the second conductive polymer layer,
211: a polycarbonate substrate,
212: a SiO₂ layer,
213: an IZO transparent electrode,
214: the first conductive polymer layer,
215: an electrolyte layer,
216: an IZO transparent electrode,
217: a ZnS.SiO₂ insulator layer,
218: a polycarbonate substrate,
219: the first layer,
220: the second layer,
221: the third layer,
222: the fourth layer,
230: a polycarbonate substrate,
231: an ITO electrode layer,
232: an electrochromic layer,
233: an electrolyte layer,
234: an ITO electrode layer,
235: a polycarbonate substrate,
240: energy of an electron,
241: an energy level of a tungsten atom (V),
242: an energy level of a tungsten atom (VI),
243: inter-valence transition,
251: leucoemeraldine,
252: emeraldine,
253: pernigraniline,
301: polyalkylene carbonate (PAC),
302: polymerization degree,
303: an alkyl group,
304: polypropylene carbonate,
305: polyethylene carbonate,
310: a transparent electrode layer,
311: the first conductive polymer layer,
312: an electrolyte layer,
313: the second conductive polymer layer,
314: a lithium ion,
315: an anion, and
316: an electron.

### DETAILED DESCRIPTION OF THE INVENTION

Composition of the present invention for solving the above problems is described below.

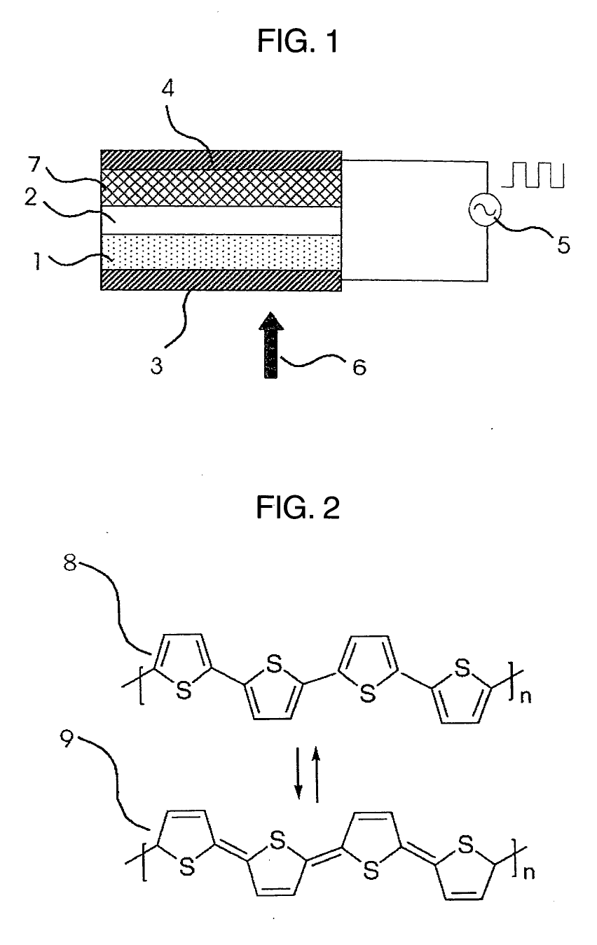

A basic unit of an information recording medium of the present invention is composition shown by a cross-sectional view in FIG. 1. The basic unit has structure comprising the first conductive polymer layer 1 comprising a conductive polymer electrochromic material, an electrolyte layer 2 located adjacent to the first conductive polymer layer 1, having ions diffusing to the first conductive polymer layer 1 by voltage impression, the second conductive polymer layer 7 adjacent to the electrolyte layer 2 at the other side of the first conductive polymer layer 1, the first electrode 3 and the second electrode 4 each sandwiching the both sides of the electrolyte layer 2 sandwiched by the first conductive polymer layer 1 and the second conductive polymer layer 7. Structure of the electrolyte layer 2 sandwiched by the first conductive polymer layer 1 and the second conductive polymer layer 7 in the basic unit is called an information layer hereinafter.

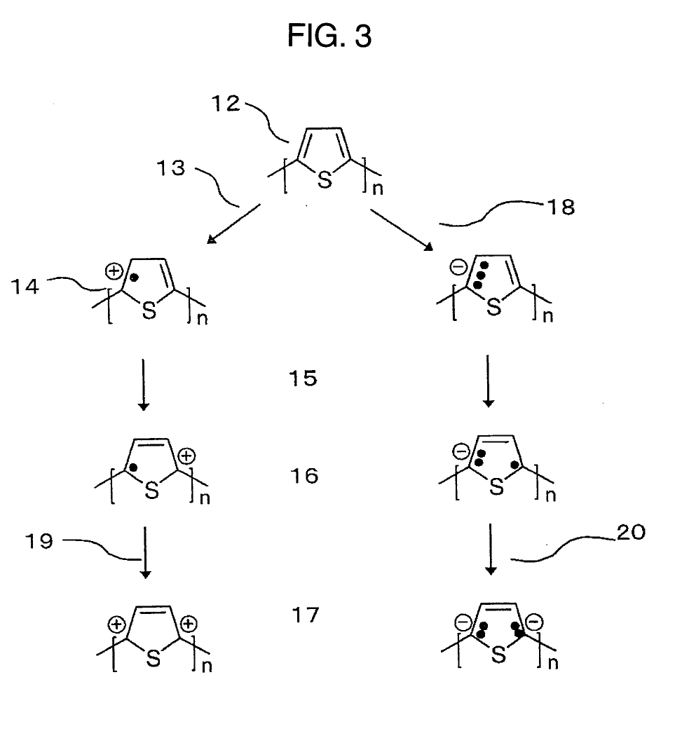

A conductive polymer electrochromic material means here a polymer having semiconductor-like conductivity and also a material changing color thereof (absorption spectrum) reversibly on voltage impression. The conductive polymer electrochromic material includes polyacetylene, polyaniline, polypyrrole, polythiophene and derivatives thereof, which are conjugated polymers linked by a conjugated double bond or a triple bond. Electrochromism of these conductive polymer electrochromic materials is based on principle described below taking polythiophene as an example. FIG. 2 shows electron resonance structure of polythiophene in ground state, which can take two types of structure, that is aromatic type structure 8 and quinoid type structure 9. Ground state of polythiophene is not degenerate as aromatic type structure 8 and quinoid type structure 9 are not equivalent in energy, that is, energy of aromatic type structure 8 is lower than that of quinoid type structure 9. Similarly, other polymers such as polyaniline, polypyrrole, polythiophene and polyphenylenevinylene are not degenerate in ground state, that is, nondegenerate type conductive polymers. Electrochromism of nondegenerate type conductive polymers can be interpreted by a polaron and a bipolaron shown below according to “Physical Review B, vol. 28, No. 4, pp. 2140-2145 (J. C. Street et. al.)”. FIG. 3 shows a change in molecular structure of polythiophene caused by doping. When polythiophene is doped with an acceptor, in neutral state 12, one electron oxidation 13 occurs first to form 1 electron oxidized state 14. An acceptor to be used for doping here includes halogens such as Br₂, I₂ and Cl₂, Lewis acids such as BF₃, PF₅, AsF₅, SbF₅, SO₃, BF₄⁻, PF₆⁻, AsF₆⁻ and SbF₆⁻, proton acids such as HNO₃, HCl, H₂SO₄, HClO₄, HF and CF₃SO₃H, transition metal halides such as FeCl₃, MoCl₃ and WCl₅, and organic compounds such as tetracyanoethylene (TCNE) and 7,7,8,8-tetracyanoquino-dimethane (TCNQ). One electron oxidized state 14 becomes polaron state 16 charged positively via a relaxation step 15. According to the Rikagakujiten, the 5th edition (1998, published by Iwanami Shoten), polaron means state wherein a conduction electron in a crystal is moving around causing deformation of surrounding crystal lattices. As for polaron state in this specification, “deformation of crystal lattices” is regarded as “advent of partial quinoid structure of a polythiophene molecule by one electron oxidation” by replacing “crystal” with “neutral state of a polythiophene molecule”. Further doping of polythiophene in polaron state 16 with an acceptor advances oxidation leading to a positively charged bipolaron state 17. On the other hand, in doping with a donor, a negatively charged polaron or bipolaron is also formed by a reduction reaction 18. A donor used for doping includes alkali metals such as Li, Na, K and Cs, and quaternary ammonium ions such as tetraethyl ammonium and tetrabutyl ammonium. Both of a polaron and a bipolaron move on a polymer chain thus contributing to electric current. Besides the above dopants, it is also possible to use a polymer electrolyte called a polymer dopant such as polystyrene sulfonic acid, polyvinyl sulfonic acid and sulfonated polybutadiene. Polymerization in the presence of these polymer electrolytes to obtain polyaniline, polythiophene and polypyrrole, provides a conductive polymer as an ion complex with a polymer electrolyte used. Use of a polymer dopant is effective in improving processability, such as converting an insoluble conductive polymer soluble in a solvent.

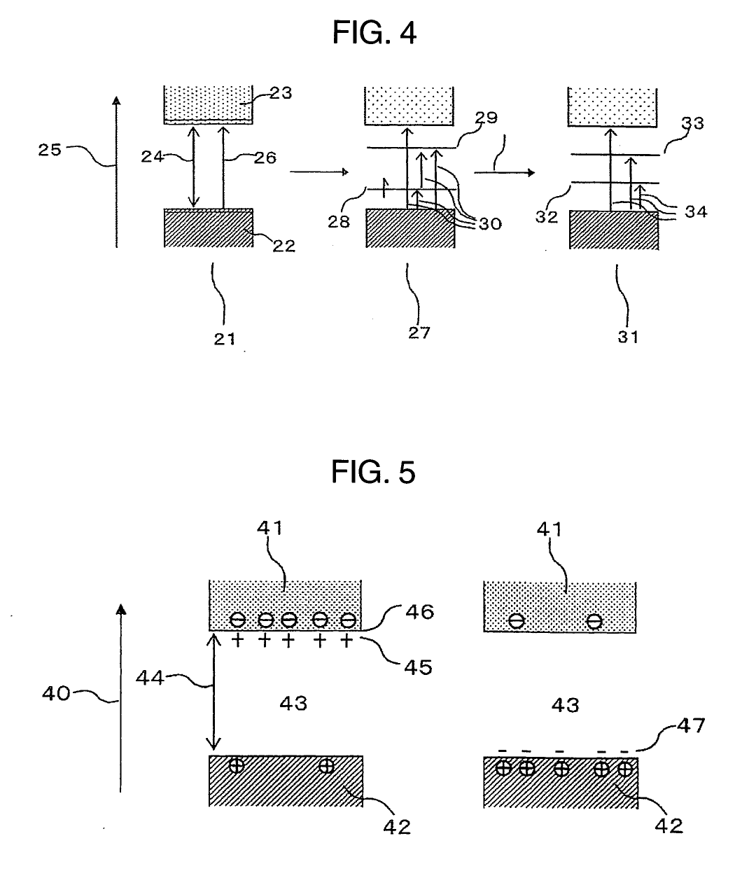

Relation between a polaron or a bipolaron and electrochromism is interpreted by FIG. 4 showing electronic state of a nondegenerate conductive polymer using band structure. Change in electronic state with acceptor doping is shown here. In band structure 21 of neutral state not subjected to doping, difference in electron energy 25 called a forbidden band width 24 is present as difference between ground energy of a valence band 22 and excited energy of a conduction band 23, and light having energy corresponding to the forbidden band width 24 is absorbed as allowable transition 26. An absorbed light wavelength in the range of a visible light wavelength provides visible color. The forbidden band width 24 of a nondegenerate conductive polymer here is generally from 0.1 eV to 3 eV, similar to that of an inorganic semiconductor. In band structure 27 in positively charged polaron state formed by acceptor doping, two polaron levels of a bipolaron level P⁺28 and a bipolaron level P⁻29 are formed between a valence band 22 and a conduction band 23. Difference between the allowed transition 30 in polaron state and the allowed transition 26 in neutral state changes light absorption characteristics, causing color change in visible light range. In band structure 31 in bipolaron state subjected to further doping, two bipolaron levels of a bipolaron level BP⁺32 and a bipolaron level BP³¹ 33 are newly formed between a valence band 22 and a conduction band 23. Resulting further change in an allowed transition 34 in bipolaron state causes further change in light absorption characteristics. Similarly, in donor doping of a nondegenerate conductive polymer, behavior change in the allowed transition caused by band structure change with formation of a polaron level and a bipolaron level is observed as electrochromism.

Band structure of a nondegenerate conductive polymer is quite different from band structure of an inorganic semiconductor represented by a silicon-based material. FIG. 5 shows electronic state in the vicinity of a lattice constant in an inorganic semiconductor crystal, using band structure. An upper portion of the figure shows higher electron energy 40. A forbidden band 43 is located between the bottom of a conduction band 41 and the top of a valence band 42 and energy difference thereof corresponds to a forbidden band width 44.

For example, in an N-type semiconductor formed by doping a silicon crystal with a V-group atom such as P, As and Sb, one electron in the outermost shell of a V-group atom is located at a donor level 45 just under a conductive band 41. Energy difference between the bottom 46 of the conduction band and the donor level 45 is so small that the electron at the donor level 45 can easily move to the conduction band 41. The electron moves toward the plus potential side when it is placed in electric field, and thus current flow is observed.

On the other hand, in a P-type semiconductor formed by doping a silicon crystal with boron (B), a III-group atom, the boron atom replaces a silicon atom, forming an acceptor level 47 at an energy level just above the valence band 42. An electron present in the valence band 42 is easily caught by the acceptor level and a positive hole in the valence band 42, from which the electron has escaped, moves freely in the valence band 42, and thus current flow is observed.

Tungsten oxide, a typical inorganic electrochromic material having properties of an inorganic semiconductor, changes reversibly its color from colorless (or pale yellow) to dark blue with intercalation into a crystal lattice of a hydrogen ion or an alkali metal ion such as a lithium ion by voltage impression. Such electrochromism of tungsten oxide is due to absorption caused by inter-valence transition in mixed valence state of hexavalent and partially reduced pentavalent tungsten atoms, and can be interpreted using FIG. 8. In this Fig., 240 shows electron energy. The conduction band of tungsten oxide is composed of the 5d orbit of a tungsten atom. In mixed valence state, inter-valence transition 243 from an energy level 241 of a tungsten atom (V) to an energy level 242 of a tungsten atom (VI) occurs, which brings about coloring. Electrochromism of molybdenum oxide, iridium oxide, manganese dioxide, nickel oxide, Prussian blue (iron-cyano complex in mixed valence state of bivalence and trivalence) or the like is based on similar principle. Since electrochromism of inorganic electrochromic materials is caused by ion intercalation into a crystal lattice, both of coloring speed and decoloring speed is slow, and switching between coloring state and decoloring state requires one minute or more.

Because electrochromic characteristics related to doping of a nondegenerate conductive polymer are used for recording, the nondegenerate conductive polymer is referred to as “conductive polymer electrochromic material” especially in this specification.

A method for optical recording and reproduction in the case of a single information layer will be discussed using FIG. 1. An electrolyte layer 2 is installed adjacent to the first conductive polymer layer 1 comprising a conductive polymer electrochromic material. Ions contained in the electrolyte layer 2 diffuse into an information layer 1 by voltage impression, using a power source 5, between the first electrode 3 and the second electrode 4 which sandwich the first conductive polymer layer 1 and the electrolyte layer 2. Diffusing of the ions contained in the electrolyte layer 2 into the first conductive polymer layer 1 is referred to as “doping” hereinafter. Light absorption characteristics of the first conductive polymer layer 1, that is, color can be changed reversibly by voltage control. It is possible to optionally select state having absorption for recording light 6, that is, colored state, and state not having absorption for recording light 6, that is, decolored state. When a region in absorption state for recording light 6 is exposed to light 6, recording by generated heat, that is, thermal recording occurs resulting in decrease in electrochromic nature. Decrease in electrochromic nature here means that an exposed region that could originally take both of colored state and decolored state can not be colored and defined that the value obtained by subtracting light transmittance (percent) of an information layer in colored state before recording from light transmittance (percent) of the information layer after recording is 20% under specified voltage impression condition to provide color to the information layer in recording. Recording light 6 may be irradiated from the opposite side, that is, from the electrolyte layer 2 side.

Function of the second conductive polymer layer 7 adjacent to an electrolyte layer 2, that sandwiches the first conductive polymer layer 1 and the electrolyte layer 2, is as follows. It increases coloring and decoloring effects of the first conductive polymer layer 1, more specifically, increases color density and shortens periods required for coloring and decoloring.

More detail is explained using FIG. 20. FIG. 20 shows voltage impression state between a pair of transparent electrodes for coloring the first polymer layer. In FIG. 20, 310 is a transparent electrode, 311 is the first conductive polymer layer, 312 is an electrolyte layer, 313 is the second conductive polymer layer, 314 is a lithium ion, 315 is an anion and 316 is an electron. The electrolyte layer 312 comprises a lithium salt represented by the formula LiA (A is selected from Cl, Br, I, CF₃SO₃ and ClO₄) as an electrolyte. In structure without the second conductive polymer layer as shown in FIG. 20(a) for example, a lithium ion 314 in the electrolyte layer 312 moves to the first conductive polymer layer side, which lowers concentration of the lithium ion 314 in the electrolyte layer 312, in voltage impression state as in FIG. 20, compared with steady state. In such chemically nonequilibrium concentration state, ion movement by voltage impression tends to be saturated. On the other hand, structure, having the second conductive polymer layer 313 shown in the right Fig., is characterized in that concentration change of a lithium ion 314 and an anion 315 is suppressed, leading to relatively less saturation of ion movement on voltage impression similarly for the element of the left side structure and on electric field inversion. Less saturation of ion movement has improving effect of repeating characteristic of coloring and decoloring by doping and dedoping by a lithium ion and thus durability improvement against repeated coloring also. Therefore, the presence of the second conductive polymer layer 313 improves coloring efficiency of the first conductive polymer layer 311, increases response speed and improves repeating characteristics. It is more preferable that the second conductive polymer layer 313 is colored by voltage impression for coloring the first conductive polymer layer 311 due to providing increase in coloring efficiency.

FIG. 1 is used again for the following explanation. The second conductive polymer layer 7 may be colored or not colored on voltage impression between the first electrode 3 and the second electrode 4 aiming at coloring the first conductive polymer layer 1. However, when the first conductive polymer layer 1 is not colored, the second conductive polymer layer 7 is not colored definitely.

A region once subjected to recording is not colored any more even under the conditions of coloring a region not yet subjected to recording. In other words, light transmittance of a region subjected to information recording of the first conductive polymer layer is maintained higher than light transmittance of specified region not subjected to light irradiation of the first conductive polymer layer, by light irradiation on decoloring the conductive polymer layer after information recording. Therefore, record reproduction is performed by detecting transmittance and reflectance of reproduction light 6, as the region subjected to recording is not colored when voltage is impressed between the first electrode 3 and the second electrode 4, using a power source 5 under the same condition as in coloring the first conductive polymer layer 1 before recording. Reproduction here should be performed with such light intensity as not to induce decrease in electrochromic nature, which is not higher than 20% of light intensity required for recording. Voltage between the first electrode 3 and the second electrode 4 required for recording and reproduction is from 3 V to 5 V when setting the first electrode 3 side positive.

Following four types of recording mechanisms are considered possible by which electrochromic nature is decreased due to heat.

a. Conversion rate to polaron state and bipolaron state by doping is lowered, caused by scission of a conjugate part, conversion from a double bond to a single bond or the like occurring in a conductive polymer having electrochromic nature in an information layer,

b. Local resistivity increases against reversible doping to an information layer, caused by curing reaction, crystallization reaction or the like by cross-linking or polymerization in an electrolyte layer.

c. Resistivity increases, caused by chemical reaction such as thermal curing at the interface between an information layer and an electrode layer adjacent thereto.

d. Resistivity increases, caused by chemical reaction such as thermal curing at the interface between an information layer and an electrolyte layer adjacent thereto.

Recording is possible when at least one of the above items from (a) to (d) occurs, while high sensitivity recording is possible when two or more of the above items occur at the same time.

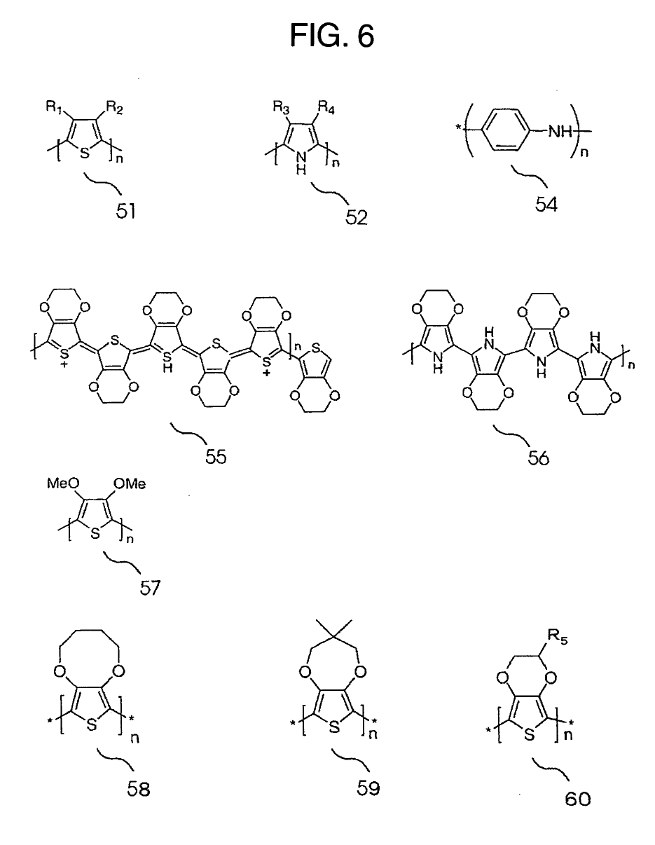

A conductive polymer electrochromic material used for the first conductive polymer layer 1 includes a conductive polymer such as polythiophene 51, polypyrrole 52, polyaniline 54, poly(3,4-ethylenedioxythiophene) 55, poly(3,4-ethylenedioxypyrrole) 56, poly(3,4-ethylenedimethoxythiophene) 57, poly(3,4-butylenedioxythiophene) 58, poly(3,4-dimethyl-3,4-dihydro-2H-thieno[3,4-b][1,4]dioxepin) 59 and alkylated derivatives 60 of poly(3,4-ethylenedioxythiophene) shown in FIG. 6, as well as ion complexes thereof with polystyrene sulfonic acid, polyvinyl sulfonic acid or the like. Polythiophene 51 and polypyrrole 52, wherein the substituent R₁ is selected from a butyl group, a hexyl group, an octyl group and a decyl group are soluble in an organic solvent and thus suitable for formation of an information layer by casting or spin coating. Further, ion complexes of the above conductive polymers and polystyrene sulfonic acid are water-soluble and thus suitable for formation of an information layer by casting or spin coating. An information layer can be formed by casting or spin coating after dissolving a conductive polymer electrochromic material in water or an organic solvent, deposition and electrolytic polymerization on an electrode using a monomer. An information layer may be laminated by spin coating or deposition on an electrolyte layer formed on an electrode. It is desirable for an information layer to have light transmittance of not lower than 90% in decolored state and light transmittance of not higher than 60% in colored state. Thickness of an information layer is desirably not thicker than 100 nm.

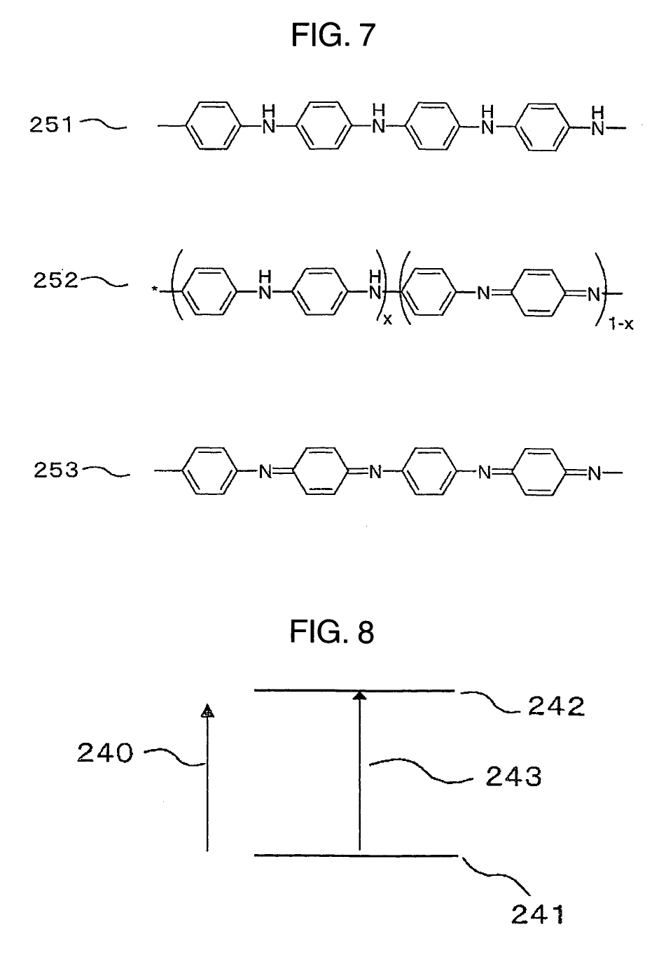

Polyaniline and derivatives thereof are used for the second conductive polymer layer 7. Polyaniline is used as, for example, a material of a positive pole material of a cell or an antistatic coating material. A Polymer such as polystyrene sulfonic acid, polymethyl methacrylate and polyvinyl alcohol may be mixed with polyaniline. Polyaniline can take several oxidation stages. As shown in FIG. 7, it is roughly divided into three types of leucoemeraldine 251, the most reduced state; emeraldine 252, a partially oxidized state; and pernigraniline 253, the most oxidized state. Emeraldine 252 is soluble in an organic solvent such as NMP.

When voltage is impressed, so that the first conductive polymer layer side is charged negatively, to an element with structure shown in FIG. 1 and composed of an electrolyte layer comprising, for example, a lithium salt, sandwiched by the first conductive polymer layer comprising poly(3,4-ethylenedioxythiophene) and the second conductive polymer layer comprising an emeraldine salt of polyaniline, and further sandwiched outside thereof by a pair of electrode layers, lithium ions diffuse into the first conductive polymer layer resulting in reduction of poly(3,4-ethylenedioxythiophene) and coloring into blue. At the same time, anions derived from the lithium salt diffuse into the second conductive polymer layer, where polyaniline is oxidized to a composition close to pernigraniline, thus increasing visible range absorbance of the second conductive polymer layer. Such changes in an absorption spectrum corresponding to oxidation stages of polyaniline are reported in “Polymer” vol. 34, page 1833, A. G. MacDiarmid et. al. As the second conductive polymer layer and the first conductive polymer layer are colored at the same time, color density and coloring efficiency are higher than those for an element with single structure without the second conductive polymer layer. In addition, polyaniline used for the second conductive polymer layer is easily oxidized and reduced, contributing to higher speed of coloring and decoloring.

A liquid electrolyte, a gel electrolyte and a solid electrolyte can be used for an electrolyte layer. However, a solid electrolyte is preferable, because a liquid electrolyte and a gel electrolyte require a spacer or sealing mechanism and are difficult to make thin film due to poor mechanical strength and also expensive to produce, although having superior conductivity. A solid electrolyte is composed of an ion conductive polymer as a supporting medium and an electrolyte salt as a dopant to an information layer. An ion conductive polymer used here includes polymethyl methacrylate, polyethylene oxide, polypropylene oxide, a copolymer of ethylene oxide and epichlorohydrin, polycarbonate and polysiloxane. An electrolyte salt that can be used includes such as lithium perchlorate (LiClO₄), lithium triflate (CF₃SO₃Li), lithium hexafluorophosphate (LiPF₆), lithium tetrafluoroborate (LiBF₄) and N-lithiotrifluoromethane sulfonimide (LiN(SO₃CF₃)₂). A plasticizer and a surfactant such as propylene carbonate and ethylene carbonate may be added to enhance ion conductivity of an electrolyte layer.

An electrolyte layer is formed by coating an ion conductive polymer and an electrolyte salt dissolved in an organic solvent such as acetone, acetonitrile, 2-propanol, diethylene glycol dimethyl ether, methyl ethyl ketone and cyclohexanone on an electrode or an information layer by spin coating or the like, and then evaporating the solvent. Thickness of an electrolyte layer is desirably from 10 nm to 100 nm.

Metal oxides such as ITO (indium tin oxide), indium oxide (In₂O₃), tin oxide (SnO₂) and IZO (indium zinc oxide) as well as metals such as aluminum, gold, silver, copper, palladium, chrome, platinum and rhodium are used for electrode layers that sandwich an information layer and an electrolyte layer adjacent thereto. High light transmittance is required for the electrode layer at the front side viewed from light introduction for recording and reproduction, desirably not lower than 85%. A method for forming an information layer includes RF sputtering, reactive sputtering, CVD (chemical vapor deposition), ion plating, vacuum deposition and oxidation processing.

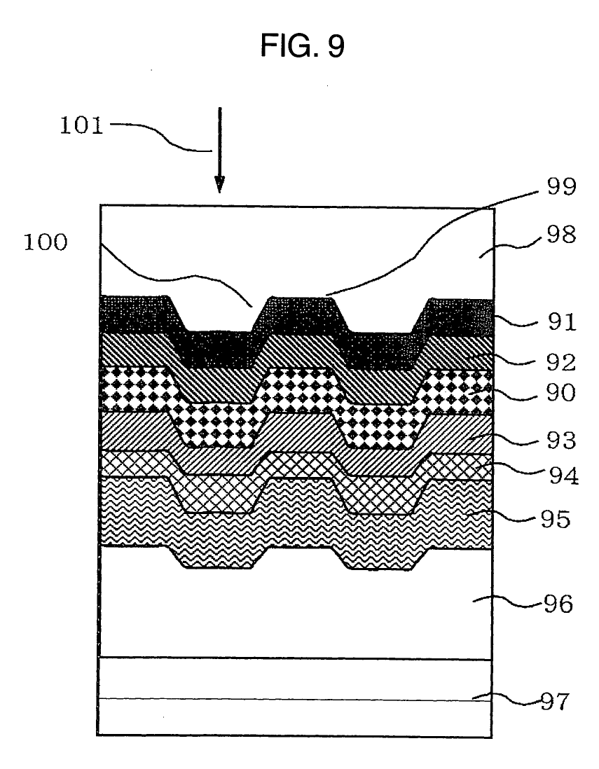

An information recording medium of the present invention is suitable for use in a form of an optical disc such as CD-R and DVD-R, mounting current supplying mechanism to an information layer on a record reproduction device. Medium mechanism in this case is shown in FIG. 9. Light is shown to come in from upper side of the drawing. The medium is composed of, in the order from light entry side, a substrate 98, a protecting layer 91, the first electrode layer 92 which is a transparent electrode, the first conductive polymer layer 90, an electrolyte layer 93, the second conductive polymer layer 94, the second electrode layer 95, a UV cure type resin layer 96 and a plastered protecting substrate 97, wherein 99 and 100 corresponds to a groove part and a land part, respectively.

In the present invention, a concave part on a substrate is referred to as a groove. A part between grooves is referred to as a land. When light comes in through a substrate to a film, a groove looks convex viewed from the light entry side. In the case of so-called in-groove recording where recording is performed in either a groove or a land, recording in a convex part viewed from the light entry side often gives better recording characteristic for both cases of light entry from the substrate side and from the opposite side of the substrate. However, the difference is so small that recording may be performed in a concave part viewed from the light entry side.

At least one electrode of the first and the second electrodes is preferably divided into multiple sections. An electrode radially divided in multiple is suitable for CAV (constant angular velocity) recording and ZCAV (zoned CAV) recording and can provide higher response speed due to smaller capacity between electrodes possible.

An information recording medium of the present invention is suitable for multilayer recording aiming at higher recording density. A medium capacity increase by higher recording density can be attained by multilayer structure laminated with the above unit structure. Although multilayer is desirable to enhance effective recording density (effective surface density), however, light transmittance and recording sensitivity of each layer are not compatible for a multilayer of not less than 3 layers in a conventional medium, and therefore, either reproduction signal quality or recording sensitivity could not help being sacrificed. Although a transparent organic material, where three-dimensional recording is possible including thickness direction, is known, a material utilizing two-photon absorption has very poor recording sensitivity, while a material utilizing photopolymerization has poor storage stability and recording sensitivity. Contrarily, in the present invention, a relevant information layer absorbs light only in recording and reproduction, and therefore a no-relevant information layer does not pose any obstacle against recording and reproduction. Unlike a conventional DVD with plural layers, which select a layer by shifting focus of a laser beam for recording or reading, a medium of the present invention does not require any spacer layer, and is therefore able to stack many layers within focal depth of a diaphragm lens, resulting in more layers and larger capacity than a conventional multi layer disc. An information layer not located within focal depth may be used for recording and reproduction by shifting a focus position. In such a case, pits or grooves representing address information may sometimes be deformed when multilayered. Consequently, it is sometimes necessary to relocate a layer on which pits or grooves are transcripted, for example, at the middle, so that the address of at least one part of a layer within the depth of focus can be read at the shifted focus position.

A medium with structure shown by FIG. 1 can be used in a single layer, or it is also possible to make multilayer thereof. In use of multilayer thereof, adjacent up and down layers may share an electrode layer or may have their own.

When an information recording medium of the present invention is used as an optical disc, it is also possible to set recording laser power from not lower than 0.2 mW to not higher than 2 mW even under a condition of a recording linear velocity of not lower than 15 m/s. Power shortage can be avoided and thus high speed transfer can be attained by realizing such high sensitivity even in a high linear velocity recording or even when an array laser or a surface-emitting laser is used as a means of light irradiating on plural sites on a recording medium at the same time. Voltage may be impressed simultaneously over at least two pairs of electrodes among plural pairs of electrodes of a recording medium. This is necessary for a material, when color thereof changes unless low voltage impression is maintained.

Voltage is impressed over many pairs of electrodes in a recording medium having plural information layers, and different voltage from that over other electrodes may be impressed over only electrodes sandwiching a layer that performs recording or reading.

When transferring from a certain information layer to other information layer in recording or reading, a layer that has been subjected to recording or reading so far is decolored and a layer for new recording or reading is colored by changing impression voltage over electrodes after once stopping laser radiation for recording or reading.

Only when transferring from front side layer, viewed from introduction direction of laser for recording or reading, to inner side layer, coloring the inner side layer may be started before decoloring the front side layer after completion of recording or regenerating, to shorten waiting time for layer switching in pursuit of high-speed processing.

With regard to equipment, plural electrodes are installed at the locations contacting a rotating shaft of a disc rotation motor or a disc center hole of a disc holder attached to the rotating shaft, along with a means for positioning the electrodes in opposing position to specified each electrode at the disc center hole in disk mounting, and a means for contacting the electrode at the rotating shaft side with the electrode at the disc side. With these means, specified voltage can be impressed over each electrode.

An information recording medium of the present invention is characterized in installing protrusion with taper in a vertical direction at a rotating shaft for disk rotation motor, attached with plurally divided electrodes at the height thereof where a disc is set, or at least one location of the circumference of the side surface of the disc holder attached to the rotating shaft. Disc rotation direction can be positioned by this mechanism and thus precise power supply to multi layer electrodes can be secured.

The present invention achieves effects at recording density (track pitch, bit pitch) equivalent or above 2.6 GB DVD-RAM Standard and, in particular, fulfils effect at recording density equivalent or above 4.7 GB DVD-RAM Standard. When wavelength of light source is not around 660 nm, or when numerical aperture (NA) of a condenser lens is not 0.6, the present invention achieves effect over recording density converted by ratio of wavelength and NA ratio in both radial and circumferential directions, and particularly achieves effect in a optical disc such as the next-generation Blue-ray Standard using a purple-blue laser of about 410 nm emission wavelength.

An information recording medium of the present invention enables to realize a far greater multilayer than ever and much larger recording capacity per recording medium by enhancing effective recording density.

### DESCRIPTION OF THE PREFERRED EMBODIMENTS

### EXAMPLE 1

(Composition and Manufacturing Method)

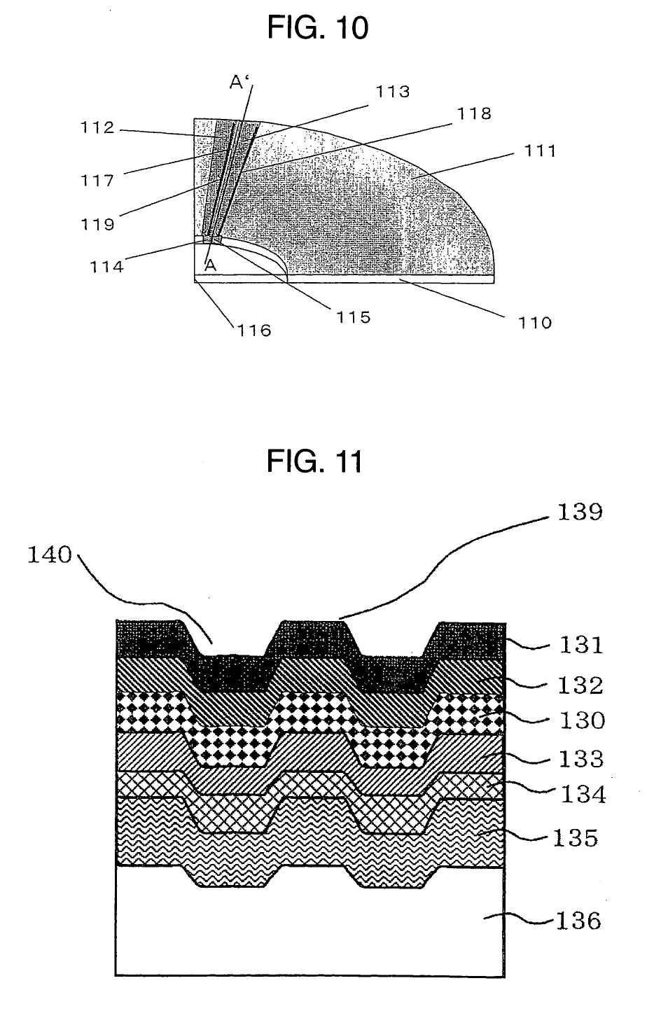

FIGS. 10 and 11 show structure of disc type information recording medium of Example 1 of the present invention. FIG. 10 shows structure of ¼ part of the disc and FIG. 11 is a magnified view of a further part thereof. There are many radial transparent electrodes with the same shape, placed at disc whole surface, shown at the upper part of FIG. 10, however, only two of them are drawn. Record and reproduction light enters from upper area through substrate, however, the most upper substrate part is omitted in this Fig. Generally, in many cases, record and reproduction are performed at area called disc groove, however, the present Example shows recording at land area. Cross cut drawing at front part of FIG. 11 corresponds to a part of A-A′ cross section in FIG. 10, while cut part of an upper electrode in FIG. 10 corresponds to clearance between radial electrodes in FIG. 10. Total A-A′ cross section is such that already shown in FIG. 9.

Medium was prepared as follows. First, as shown in FIG. 11, a transparent electrode (ITO) 135 (with film thickness of 50 nm) having composition of (In₂O₃)₉₀(SnO₂)₁₀ was formed on polycarbonate substrate 136, giving tracking grooves (having width of 0.35 μm) for in-groove recording (in this case, land recording in view of light spot) with track pitch of 0.74 μm and depth of 23 nm at surface with 12 cm diameter and 0.6 mm thickness, and address being expressed by groove wobble. Groove patterns were transcribed to substrate surface by using mother prepared by once transcribed from nickel master obtained by exposure to photoresist, so that grooves exposed to photoresist could correspond to land. This transparent electrode is separated into radial-like 20 regions corresponding to recording sectors by forming using masked sputtering.

Then the first conducting polymer layer 134 was formed to have average film thickness of 100 nm. A conducting polymer electrochromic material used as an information layer was coated with an aqueous solution dispersed with poly(3,4-ethylenedioxythiophene) (0.5% by weight) and polyvinyl sulfonate (0.8% by weight) using a spin coater under 3000 rpm rotation number, followed by removal of water at 100° C. for 5 minutes on a digital hot plate.

Then an electrolyte layer 133 was formed to thickness of 100 nm by coating with an acetonitrile solution of polymethyl methacrylate (number average molecular weight of 30,000) (5% by weight), propylene carbonate (15% by weight) and lithium perchlorate (7% by weight) using a spin coater under condition of 1000 rpm rotation number, followed by removal of acetonitrile at 100° C. for 5 minutes on a digital hot plate.

The second conducting polymer layer 130 was formed to have film thickness of 30 nm on the electrolyte layer 133 by coating with an N-methylpyrrolidinone solution of polyaniline emeraldine salt (0.5% by weight) using a spin coater under condition of 1500 rpm rotation number, followed by heating at 100° C. for 4 minutes on a digital hot plate.

Reflecting layer and for the second electrode layer 132, consisted of W₈₀Ti₂₀ film with thickness of 50 nm was formed on the second conducting polymer layer 130. This laminated film was formed by using magnetron sputtering equipment.

A protecting layer 131 with thickness of 0.5 mm was formed using a UV cure type resin on the second electrode.

Fine metal (Al) electrodes 118 and 119 directed from inner peripheral toward outer peripheral, having average width in radial direction of about 100 μm, narrower than width of a radial transparent electrode, and film thickness of from 50 nm to 200 nm, were installed one per each radial transparent electrode, before installing the radial transparent electrode on substrate to prevent the effects of sheet resistance of the transparent electrode or presence of thin film part at groove convex or concave corners of the transparent electrode. These electrodes were formed on recording medium by masked sputtering. Record and reproduction were made avoiding this electrode part.

Contrary to the present Example, a transparent electrode and for a reflecting layer and for an electrode may be reversed so that incident light enters from a plastered substrate side to record in grooves looked by light spot. In this case, substrate was formed not by using mother but nickel master. Also in this case, the plastered substrate may be as thin as about 0.1 mm and diaphragm lens NA may be as big as 0.85, which can reduce track pitch to about ¾, that is 0.54 μm.

A transparent electrode may not be separated to multiple fan-type transparent electrodes and a disc as a whole may be an electrode, however, separation is preferable due to providing small capacity among electrodes thus increasing and decreasing voltage rapidly. It is particularly preferable for capacity among electrodes to be not higher than 0.1 F for period and electric current required for coloring and decoloring to be in practical range, however, structure having not lower than 0.01 F is preferable because of good element characteristics. A transparent electrode may not be separated to multiple fan-type transparent electrodes and, while a metal electrode or both upper and lower electrodes may be separated, wherein partition position of these electrodes may be or may not be coincident.

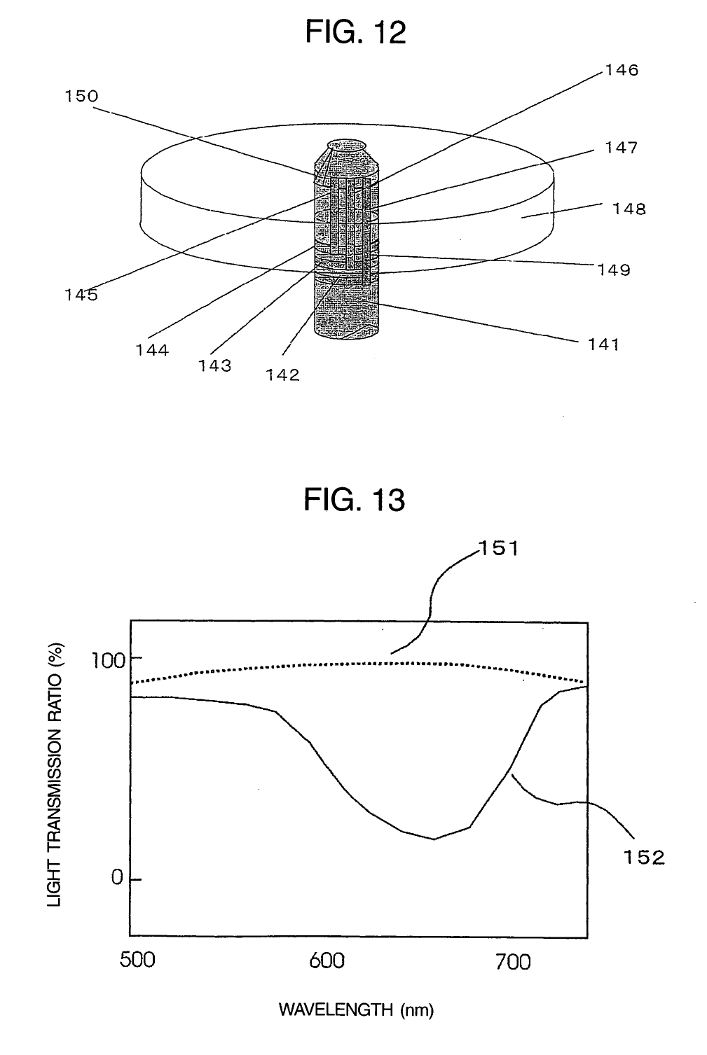

At each of the most inner peripheral part of a reflecting layer and for the above-described transparent electrode, a lead electrode is installed, so that it reaches to the most inner peripheral part of a disc to be connected with electrodes 114 and 115 at end surface of a disc center hole, to provide separate connection to other electrode on disc rotating shaft of record and reproduction equipment, as shown in FIG. 10. As shown in FIG. 12, 6 separated electrodes are adhered (in this Fig. only 3 of them 145, 146 and 147 are shown) at a high side part, where a disc is set, of a disc rotation motor axis 141, penetrating disc receive circle plate 148, to correspond up to 5 layers in the case of multilayer discs such as described later in Example 2, and at a position on circumference of the rotating shaft, there is a protrusion 150 having taper in up and down direction or concave part whose position is determined by intermeshing with a concave or convex part of the disc center hole, to provide mutual contact of specified electrodes. Each electrode of the disc rotating shaft is fed electricity from circuit substrate of recording equipment by means of combination of brushes and rings 142, 143 and 144. Other electricity feed methods may be used.

Laser beam for record reproduction was introduced from substrate side. Laser beam may be introduced from the last installed transparent electrode side, that is plastered substrate side. In this case, record film thickness was determined so that reflectance of about 10% and good read contrast ratio could be obtained.

(Electrochromic Characteristics)

Electrochromic characteristics were evaluated using an information layer of information recording medium prepared as described above. FIG. 13 is an absorption spectrum of the information layer in visible region (wavelength from 500 nm to 700 nm). It was measured in sufficient steady state, after 1 minute from start of voltage impression between electrodes at disc center part. As for voltage impression direction, an electrolyte layer side was made positive in the information layer and the electrolyte layer present adjacent each other. As shown by dotted line 151 in FIG. 13, an absorption band having a peak at 660 nm wavelength appeared on +1.5 V impression shown by solid line 152, although wavelength range from 550 nm to 700 nm was nearly completely transparent without voltage impression. Transmittance at 660 nm wavelength in this case was 40%.

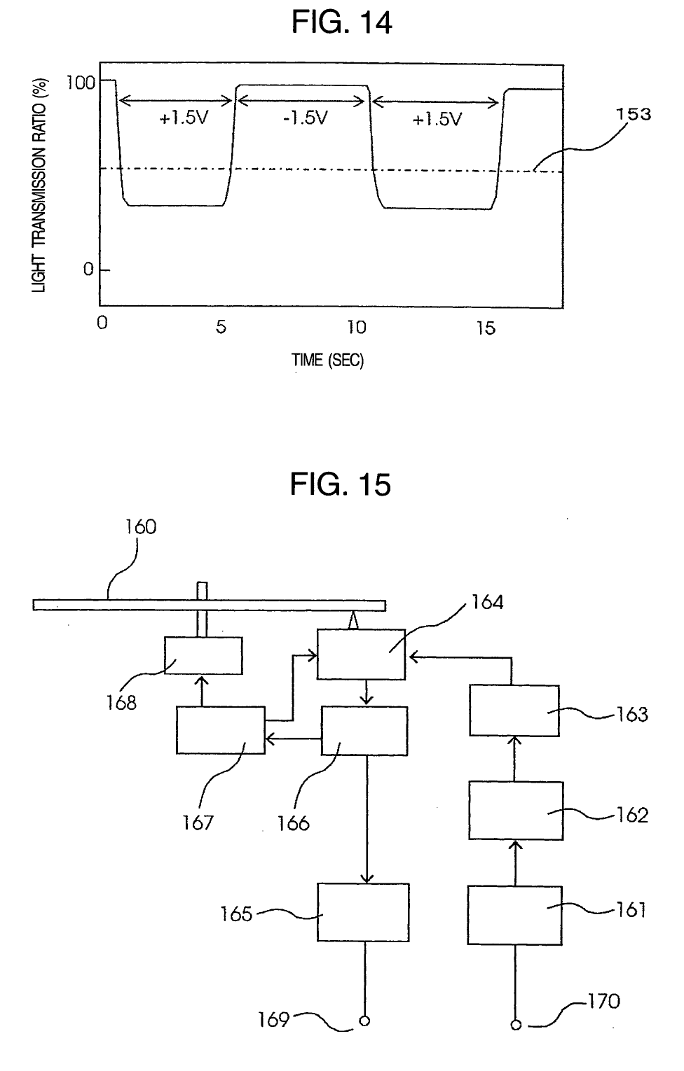

FIG. 14 shows time change of light transmittance of the information layer at 660 nm wavelength, with voltage impression shift from +1.5 V to −1.5 V. Broken line 153 shows light transmittance of 60% line, minimum coloring concentration required for record and reproduction, showing that the information layer of information recording medium prepared had sufficient coloring concentration. Period required from decolored state to return to state having coloring concentration sufficient to recording and reproduction and period from coloring state to return to decolored state were both about 0.5 second.

As Comparative Example, a similar comparative medium was prepared except that the second conducting polymer layer was omitted, to evaluate electrochromic characteristics. Voltage impression of +2.5 V was required to get color concentration equivalent to the result shown by FIG. 13. Response speed of coloring and decoloring was measured by polarity inversion of impressed voltage from +2.5 V to −2.5 V and period required from decolored state to return to state having coloring concentration sufficient to recording and reading out and period from coloring state to return to decolored state were found to be both about 1.5 second.

Therefore, the addition of the second conducting polymer layer confirmed to provide improvements of doping rate with lithium ion to the first conducting polymer layer and dedoping rate and also coloring and decoloring efficiencies.

(Record Reproduction)

Information record and reproduction were tested using the above-described information recording medium of the present invention. Mechanism of this information record and reproduction will be explained below using FIG. 15. First explanation is for the case of adopting a ZCAV (Zoned Constant Linear Velocity) system, as a motor control method in record reproduction, wherein disc rotation number is changed by each record reproduction zone.

Information from external of record equipment is transferred in 8 bits unit to an 8-16 modulator 161. To record information on information record medium 160 (hereinafter called an optical disc), a modulation system to convert 8 bits information to 16 bits, so to speak an 8-16 modulation system was used. In this modulation system, information having from 3T to 14T mark length corresponding to 8 bits information is recorded. The 8-16 modulator 161 in the figure performs this modulation. T here represents clock cycle in information recording. A disc was rotated so as to have 15 m/sec relative linear velocity to a light spot.

3T to 14T digital signals converted by the 8-16 modulator 161 are transferred to record waveform generation circuit 162 to form multi-pulse recording waveform.

In this case, power level to form record mark, intermediate power level to be able to delete record mark and reduced power level were set to 5 mW, 2 mW and 0.1 mW, respectively. Laser power to form record mark may be decreased with increase in impressed voltage and a range from not lower than 0.5 mW to not higher than 5 mW provided good recording. Change in linear velocity from 15 m/s did not provide big change in this range. Reading was performed at 1 mW without voltage impression. A range from not lower than 0.2 mW to not higher than 2 mW provided practical reading. Long period reading by power over 2 mW deteriorated recorded data. In the above-described record waveform generation circuit, signals from 3T to 14T are made to correspond to “0” and “1” alternately in time series. In this case, a region irradiated by high power level pulse lowers electrochromic characteristics, which makes coloring difficult. In the above-described record waveform generation circuit 8-6, multi-pulse waveform table is present corresponding to a system (adaptable type record waveform control), wherein front and tail pulse widths of multi-pulse waveform are changed in response to space part length before and after mark region in forming a series of power pulse array to form mark region, by which multi-pulse waveform is generated to eliminate in maximum thermal interference effect generated among marks.

Record waveform generated by the record waveform generation circuit 162 is transferred to a laser drive circuit 163, based on which waveform the laser drive circuit 163 emits a semiconductor laser in a photo-head 164.

A semiconductor laser with wavelength of 660 nm is used as laser beam for information record in the photo-head 164 mounted on the present recording equipment. Information was recorded by focusing this laser beam on the information layer of the above-described light disc 160 by an objective lens having lens NA of 0.65.

Reflectance of medium is high in colored state, while low in decolored state by recording in an information layer using a conducting polymer electrochromic material. 2 V is continuously impressed between upper and lower electrodes of the information layer during recording by laser beam irradiation.

Therefore the present system has similar recording in varied position or concentration of a light spot and sufficient allowance against AF and tracking displacement and is thus not only highly sensitive to light but also suitable to high speed rotation record.

Contrast ratio of about 2:1 of light reflectance between record mark part and other part was obtained in an information record medium of the present Example. Contrast ratio of this value or lower provides fluctuation by reproduced signal noise over 9% and out of a practical range of reproduction signal quality. Inclusion of SiO₂ in a transparent electrode to make (SiO₂)₄₀(In₂O₃)₅₅(SnO₂)₅ is optically advantageous due to decreased refractive index of an electrode layer and could make contrast ratio 2.5:1.

It is also easy to form light spots from a single photo-head or multiple photo-heads on the same or different recording track(s) and to record simultaneously.

The present record equipment corresponds to an information recording system on land (so to speak modified version of in-groove recording system) in land and groove.

Reproduction of recorded information was also performed using the above-described photo-head. Reproduction signal is obtained by laser beam irradiation on recorded mark and detecting reflected light from marked and non-marked parts. Amplitude of this reproduction signal is amplified by pre-amplifier circuit and the signal is converted to 8 bits by each 16 bits by an 8-16 demodulator 165. Reproduction of recorded mark is completed by the operation above.

Length of 3T mark, the shortest mark, is about 0.20 μm in mark edge recording under the above-described conditions, while length of 14T mark, the longest mark, is about 1.96 μm. Recording signal contains dummy data having repeated 4T mark and 4T space at start and terminal end parts of information signal and the start end part includes VFO also.

(Mark Edge Recording)

A mark edge recording system is adopted in DVD-RAM and DVR-RW to attain high density recording. In the mark edge recording system, both ends positions of recording mark formed on recording film correspond to digital data “1”, by which length of the shortest recording mark can be matched to not one but 2 to 3 base clocks to provide high density recording. DVD-RAM adopts an 8-16 modulation system to match to 3 base clocks. A mark edge recording system has merit of high density recording without significant reduction of recording mark size compared with mark position recording wherein center position of circular recording mark corresponds to digital data 1. However, only small shape deformation of recording mark is allowed for recording medium.

(ZCLV Recording System, CAV Recording System)

Recording at optimal linear velocity is preferable to obtain good record reproduction characteristics without changing record waveform, in information recording medium using a conducting polymer electrochromic material. However, change in rotation number to get the same linear velocity in access between recording tracks with different radius on a disc requires time. Therefore a ZCLV (Zoned Constant Linear Velocity) system is adopted in DVD-RAM, wherein disc radius direction is divided in 24 zones not to lower access speed and constant rotation number is maintained within a zone and rotation number is changed only in access to other zone. Small difference in linear velocity between the most inner and outer circumference in a zone changes recording density a little, however, nearly maximum density recording can be possible throughout whole disc zone.

On the other hand, a CAV recording system with constant rotation number is preferable in view of any change in rotation number not necessary even in far access in radius direction, which is suitable to mobile equipment due to suppression of power consumption possible in rotation number change. The present invention, as described above, has effect to make easy CAV recording due to getting constant heating period irrespective of position in radius direction.

(Electrode Material)

It is important for an electrode material to have optical characteristics of no absorption, that is transparent, at wavelength of laser beam. A transparent electrode material preferably includes one having composition of (In₂O₃)ₓ(SnO₂)₁₋ₓ, wherein x is in the range from 5% to 99%, preferably in the range from 90% to 98% in the viewpoint of resistance value; such one obtained by adding SiO₂ in not higher than 50% by mole thereto; and SnO₂ added with other oxide such as Sb₂O₃ from 2 to 5% by mole. SnO₂ doped with fluorine can be used due to having low resistance and high light transmittance. IZO (indium-zinc-oxide) can be used as an electrode layer due to having advantage of low surface roughness and good film formability. The electrode layer at the most inner side viewed from laser beam introduction side to recording medium not necessarily requires high transparency, therefore metal preferable for optical disc can be used. A high heat conductive material, such as Al or Al alloy added with Cr or Ti element in not higher than 4% by atom, is preferable as a metal layer required to have high reflectance and heat conductivity, due to suppression effect of temperature rise at substrate surface. Such a layer may also be used as consisting of element only such as Au, Ag, Cu, Ni, Fe, Co, Cr, Ti, Pd, Pt, W, Ta, Mo, Sb, Bi, Dy, Cd, Mn, Mg and V; or an alloy mainly composed thereof such as Au alloy, Ag alloy, Cu alloy, Pd alloy, Pt alloy, Sb—Bi, SUS and Ni—Cr; or an alloy thereof. Thus, an electrode and for reflecting layer is consisted of a metal element, a metalloid element, an alloy thereof and a mixture. Among these, Cu, Ag, Au as it is or Cu alloy, Ag alloy, in particular such one as added with Pd or Cu element in not higher than 8% by atom, or Au alloy having high heat conductivity can suppress thermal deterioration of organic materials. Such a conductive organic material as polythiophene derivatives, polypyrrole derivatives and polyacetylene having no absorption band at visible region and having narrow band gap structure can also be used.

(Substrate)

A polycarbonate substrate having grooves for tracking directly at the surface was used in the present Example. The substrate having grooves for tracking means a substrate having grooves with depth of not shallower than λ/15n (wherein λ represents record and reproduction wavelength and n represents refractive index of the substrate material) at whole or partial substrate surface. The grooves may be formed continuously in a round or divided in midway. Groove depth of about λ/2n was found preferable in view of balance between tracking and noise. The groove depth may be different by position. The substrate may have format for record and reproduction at both groove and land regions or format for record at one of them. Track pitch of about 0.7 times wavelength/focus lens NA and groove width of about ½ thereof is preferable in type to record only at grooves.

(Recording Laser Power)

Recording laser power was set to be 10 mW under condition of, for example, recording linear velocity not slower than 15 m/s in the present Example.

(Reading Out Laser Power)

Reading out laser power was set to be 1 mW.

Data transfer rate could be raised 4 times by using 4 elements array laser as laser light source.

(Conductive Polymer Electrochromic Material)

Record and reproduction could also be performed using poly(3,4-ethylenedioxypyrrole) and poly(3-hexylpyrrole) as a conductive polymer electrochromic material for an information layer.

Polythiophene and derivatives thereof are superior as conductive polymer electrochromic materials due to easy doping of a donor typically such as Li+ and superior stability against oxidation in neutral state. Record and reproduction could also be performed using polythiophene, poly(3,4-propylenedioxythiophene), poly(3,4-dimethoxythiophene) and poly(3-hexylthiophene) instead of poly(3,4-ethylenedioxythiophene) as an information recording medium.

(Electrolyte Layer Material)

Record and reproduction could also be performed using polyethylene oxide, polypropylene oxide, a (70:30) copolymer of ethylene oxide and epichlorohydrin, polycarbonate and polysiloxane instead of polymethyl methacrylate as an information recording medium.

### EXAMPLE 2

The present Example relates to recording medium which enabled recording and read out using short wavelength laser. Structure of the medium and manufacturing methods therefore are the same as in Example 1.

A transparent electrode (with film thickness of 30 nm) having composition of SnO₂ was formed on polycarbonate substrate, giving tracking grooves (having width of 0.25 μm) for in-groove recording (in this case, land recording in view of a light spot) with track pitch of 0.45 μm and depth of 23 nm at surface with 12 cm diameter and thickness of 0.6 mm, and address being expressed by groove wobble. Groove patterns were transcribed to substrate surface by using mother prepared by once transcribed from nickel master obtained by plating on an original photoresist plate. This transparent electrode was formed using masked sputtering and separated into radial-like 20 regions corresponding to recording sectors.

Then the first conducting polymer layer was formed to have average film thickness of 100 nm. A conducting polymer electrochromic material used for an information layer was coated with an aqueous solution dispersed with poly(3,4-dimethoxythiophene) (0.5% by weight) and polyvinyl sulfonate (0.8% by weight) using a spin coater under 3000 rpm rotation number, followed by removal of the solvent at 100° C. for 5 minutes on a digital hot plate.

Then an electrolyte layer was formed to thickness of 100 nm by coating with a cyclohexanone solution of polymethyl methacrylate (number average molecular weight of 30,000) (5% by weight), propylene carbonate (15% by weight) and lithium perchlorate (7% by weight) using a spin coater under condition of 3000 rpm rotation number, followed by removal of cyclohexanone at 100° C. for 5 minutes on a digital hot plate.

The second conducting polymer layer was formed to have film thickness of 30 nm on the electrolyte layer by coating with an N-methylpyrrolidinone solution of a polyaniline emeraldine salt (0.5% by weight) using a spin coater under condition of 1500 rpm rotation number, followed by heating at 100° C. for 4 minutes on a digital hot plate.

A reflecting layer and for the second electrode layer, consisted of W₈₀Ti₂₀ film with thickness of 50 nm was formed on the second conducting polymer layer. This laminated film was formed by using magnetron sputtering equipment.

A protecting layer with thickness of 0.5 mm was formed using a UV cure type resin on the second electrode.

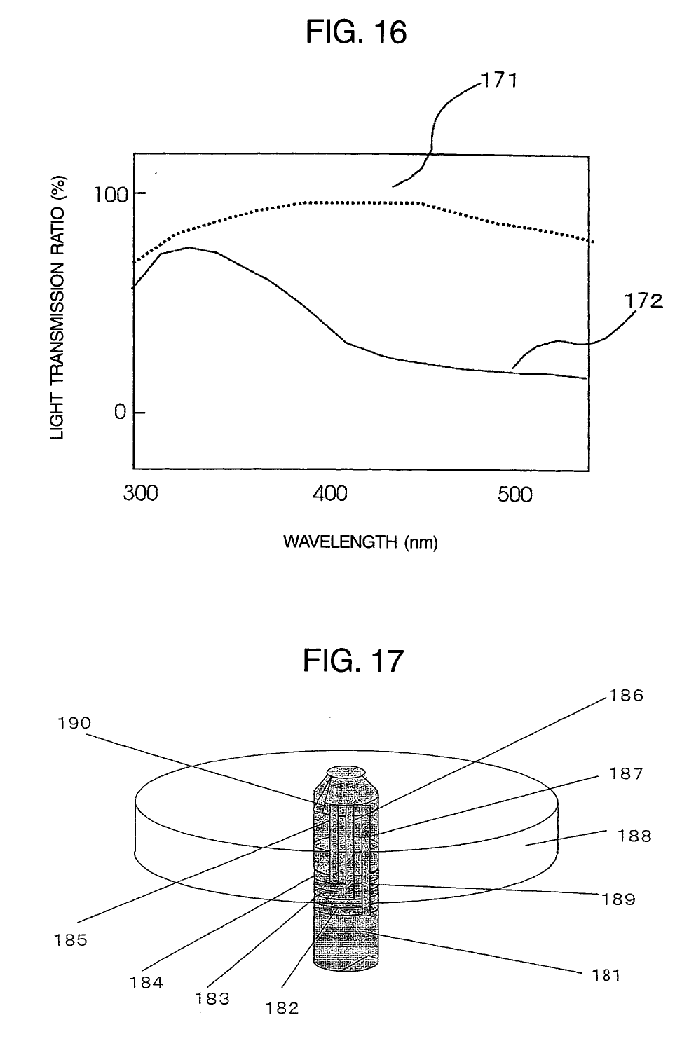

FIG. 16 is an absorption spectrum of the recording medium of the present Example under impressed voltage between the first and the second pair electrodes. It was measured in sufficient steady state, after 1 minute from start of voltage impression. As for voltage impression direction, an electrolyte layer side was made positive in the information layer and the electrolyte layer present adjacent each other. A dotted line 171 in FIG. 17 is an absorption spectrum under impression of −1.0 V, while a solid line 172 is an absorption spectrum under impression of +1.5V. An absorption band having a peak at 400 nm wavelength appeared on +2.0 V impression. Therefore, the present medium is suitable to recording using bluish-purple semiconductor laser with 400 nm wavelength.

Record reproduction was performed similarly as in Example 1, using recording medium prepared in accordance with a method in FIG. 15. A semiconductor laser with light wavelength of 400 nm was used as laser beam for information record. Information was recorded by focusing this laser beam on the information layer by an objective lens having lens NA of 0.65 and reproduction could be performed by laser beam having 1 mW intensity.

Record and reproduction could also be performed in the case of information recording medium using poly(3,4-ethoxythiophene) and poly(3-butylthiophene) as a conductive polymer electrochromic material.

### EXAMPLE 3

The present Example relates to multilayer structure recording medium and recoding equipment using thereof.

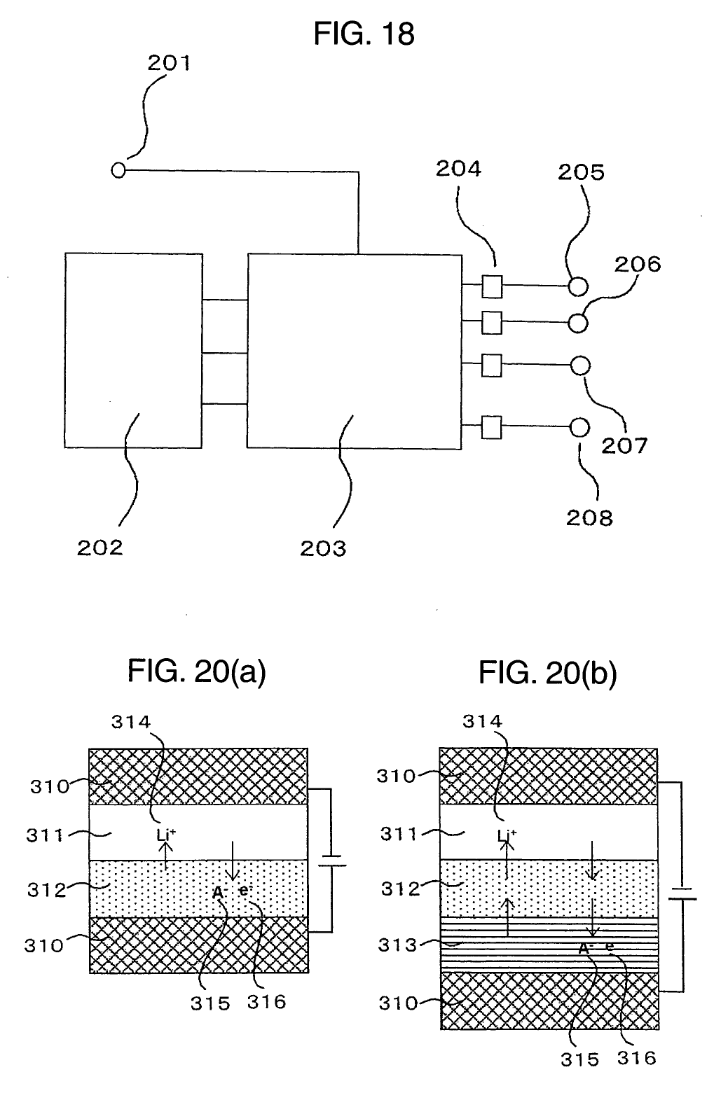

FIG. 17 shows structure of rotating shaft vicinity of recording equipment of the present Example and FIG. 18 shows block diagram of control circuit for recording equipment. Voltage and chosen signal of recording medium layer are sent to 3 slip rings 182, 183 and 184 of the rotating shaft. Circuit in FIG. 18 including a condenser is built inside a hollow part of a disc holder 188 and wiring to each layer at right end in the circuit block diagram via impressed voltage shift and control circuit is connected to electrodes 185, 186 and 187 of the rotating shaft. There are 8 electrodes, however, 5 thereof are omitted due to presence of the rotating shaft at non-view surface. Plus voltage and minus voltage are impressed to a layer to be colored and a layer to be decolored, respectively.

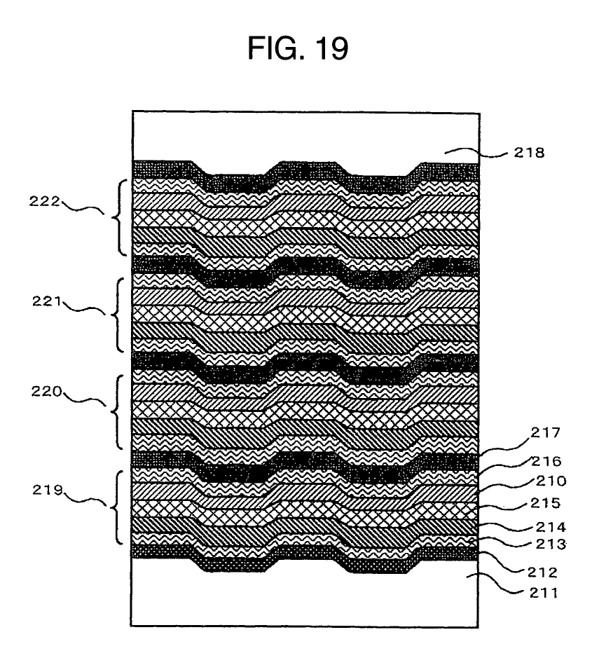

Recording medium has the same fundamental structure as in Example 1. As shown in FIG. 19, the first layer 219 was formed in the order of a SiO₂ layer (10 nm) 81, an IZO transparent layer (30 nm) 212, an information layer (composed of 3 layers of the first conductive polymer layer (50 nm) 213, an electrolyte layer (60 nm) 214 and the second conductive polymer layer (50 nm) 215), an IZO transparent electrode (30 nm) 216, on polycarbonate substrate 211, giving tracking grooves for in-groove recording with track pitch of 0.45 μm, depth of 23 nm and groove width of 0.23 μm at surface with 12 cm diameter and 0.6 mm thickness, and having address information as the above-described groove wobble.

Materials used as the first conductive polymer layer 213, the second conductive polymer layer 214 and an electrolyte layer 215 are the same as in Example 1.

Record and reproduction methods are similar as in Example 1. Selective information record and reproduction could be performed by voltage impression on transparent electrodes at both sides of an information layer for record or read out, while irradiating laser beam of 660 nm wavelength, because only a relevant layer gets color, and absorbs and reflects laser beam.

All multilayer films may be present within focal depth of focus lens, however, record and reproduction may be performed by changing focal point position by sandwiching spacer layers having from 20 to 40 μm thickness by each several layers (for example by each 3 layers). When not less than 2 spacers are used, it is preferable to install element in optical system to compensate spherical aberration.

### EXAMPLE 4

The present Example relates to record medium with improved repetition characteristics of coloring and decoloring. Medium structure and manufacturing methods therefore are the same as in Example 1.

A transparent electrode (with film thickness of 40 nm) having composition of SnO₂ was formed on polycarbonate substrate, giving tracking grooves (having width of 0.25 μm) for in-groove recording (in this case, land recording in view of a light spot) with track pitch of 0.45 μm and depth of 23 nm at surface with 12 cm diameter and 0.6 mm thickness, and address being expressed by groove wobble. Groove patterns were transcribed to substrate surface by using mother prepared by once transcribed from nickel master obtained by plating on an original photoresist plate. This transparent electrode was formed using masked sputtering and separated into radial-like 20 regions corresponding to recording sectors.

Then the first conducting polymer layer was formed to have average film thickness of 50 nm. A conducting polymer electrochromic material used for an information layer was coated with an aqueous solution dispersed with poly(3,4-ethylenedioxythiophene) (0.5% by weight) and polystyrene sulfonic acid (0.8% by weight) using a spin coater under 2000 rpm rotation number, followed by removal of the solvent at 120° C. for 5 minutes on a digital hot plate.

Then an electrolyte layer was formed to thickness of 60 nm by coating with an cyclohexanone solution of polymethyl methacrylate (number average molecular weight of 30,000) (5% by weight), propylene carbonate (15% by weight) and lithium perchlorate (7% by weight) using a spin coater under condition of 2000 rpm rotation number, followed by removal of cyclohexanone at 100° C. for 5 minutes on a digital hot plate.

The second conducting polymer layer was formed to have film thickness of 20 nm on the electrolyte layer by coating with an N-methylpyrrolidinone solution of a polyaniline emeraldine salt (0.5% by weight) using a spin coater under condition of 1500 rpm rotation number, followed by heating at 100° C. for 3 minutes on a digital hot plate.

A reflecting layer and for the second electrode layer, consisted of W₈₀Ti₂₀ film with thickness of 50 nm was formed on the second conducting polymer layer. This laminated film was formed by using magnetron sputtering equipment.

A protecting layer with thickness of 0.5 mm was formed using a UV cure type resin on the second electrode.

Record reproduction was performed similarly as in Example 1, using recording medium prepared in accordance with a method in FIG. 15. A semiconductor laser with light wavelength of 660 nm was used as laser beam for information recording. Information was recorded by focusing this laser beam on the information layer by an objective lens having lens NA of 0.65, followed by irradiation of laser beam with 10 mW intensity and could be reproduced by laser beam with 1 mW intensity.

Between a pair of electrodes of this recording medium, ±1.5 V was impressed at 0.1 Hz cycle. In this medium, record reproduction could be performed similarly even after voltage impression of 10000 cycles.

As a comparison, ±1.5 V was impressed at 0.1 Hz cycle between electrodes using recording medium prepared completely similarly except that a polyaniline layer as the second conductive polymer layer was not used. In this medium, recording light intensity of 20 mW was needed after voltage impression of 1000 cycles and record reproduction could not be performed at all after 5000 cycles.

Record and reproduction could also be performed in the case of information recording medium using poly(3,4-dimethoxythiophene), poly(3,4-ethoxythiophene), poly(3-butylthiophene), polythiophene and poly(3,4-propylenedioxythiophene) as a conductive polymer electrochromic material.

The present invention is effective in high density record/reproduction.

It should be further understood by those skilled in the art that although the foregoing description has been made on embodiments of the invention, the invention is not limited thereto and various changes and modifications may be made without departing from the spirit of the invention and scope of the appended claims.

1. An information recording medium comprising a substrate, a first conductive polymer layer to be colored by voltage impression, an electrolyte layer having ions diffusing to the first conductive polymer layer, a second conductive polymer layer and an electrode layer for impressing voltage to color the first conductive polymer layer.

2. An information recording medium according to claim 1 wherein the electrolyte layer is sandwiched by the first conductive polymer layer and the second conductive polymer layer.

3. An information recording medium according to claim 1 wherein the second conductive polymer layer comprises polyaniline.

4. An information recording medium according to claim 1 wherein a conductive polymer contained in the first conductive polymer layer is a conductive polymer electrochromic material whose light absorbance changes by taking polaron state or bipolaron state.

5. An information recording medium according to claim 1 wherein information is recorded in the first conductive polymer layer.

6. An information recording medium according to claim 2 wherein the electrolyte layer is sandwiched by the first conductive polymer layer and the second conductive polymer layer is sandwiched by a pair of electrode layers.

7. An information recording medium according to claim 1 which has plural laminated bodies composed of the first conductive polymer layer, the electrode layers, the electrolyte layer and the second conductive polymer layer.

8. An information recording medium according to claim 1, wherein recording to the information recording medium is performed by laser irradiation.

9. An information recording medium according to claim 1, wherein recording to the information recording medium is performed by laser heating.

10. An information recording medium according to claim 1, wherein the electrolyte layer is a solid electrolyte.

11. An information recording medium according to claim 10, wherein the solid electrolyte comprises at least one polymer selected from polymethyl methacrylate, polyethylene oxide, polypropylene oxide, a copolymer of ethylene oxide and epichlorohydrin, polycarbonate and polysiloxane, and at least one compound selected from lithium perchlorate (LiClO₄), lithium triflate (CF₃SO₃Li), lithium hexafluorophosphate (LiPF₆), lithium tetrafluoroborate (LiBF₄) and N-lithiotrifluoromethane sulfonimide (LiN(SO₃CF₃)₂).

12. An information recording medium according to claim 4, wherein the conductive polymer electrochromic material comprises at least one compound selected from polythiophene and derivatives thereof, polypyrrole and derivatives thereof, polyaniline and derivatives thereof.

13. An information recording medium according to claim 1, wherein the compound composing the electrode layer in the information recording medium is one of ITO (indium tin oxide), IZO (indium zinc oxide) and tin oxide SnO₂.

14. An information recording method wherein information is recorded by using an information recording medium having plural laminated films consisting of a first conductive polymer layer to be colored by voltage impression, an electrolyte layer having an ion diffusing to the first conductive polymer layer, a second conductive polymer layer and an electrode layer for impressing voltage to color the first conductive polymer layer and by coloring the first conductive polymer layer of at least one laminated film among the plural laminated films and then by irradiating light to a region including the colored layer.

15. An information recording method according to claim 14 wherein intensity of light irradiated to an information layer in information recording is higher than intensity of light irradiated to an information layer in information reproduction.

16. An information recording method according to claim 14, wherein recording is performed under the condition that light transmittance of the colored layer is lower than light transmittance of the first conductive polymer layer of the other laminated film.

17. An information recording method according to claim 14, wherein light transmittance of an information recording region of the first conductive polymer layer where information is recorded is maintained higher than light transmittance of a specified region of the first conductive polymer layer to which the light is not irradiated, by irradiating the light when the first conductive polymer layer is decolored after recording the information.
